(19) United States
(12) Patent Application Publication
(10) Pub. No.: US 2009/0036187 A1
(43) Pub. Date: Feb. 5, 2009

(54) Poker game table

(76) Inventor: Tzu-Hsiang Tseng, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/882,125

(22) Filed: Jul. 31, 2007

(51) Int. Cl. A63F 13/00

(52) U.S. Cl. 463/13

(57) ABSTRACT

A poker game table includes a first game table, which has a first table top provided with sets of operation buttons mounted and a second table top marked with the game rules and equipped with LCD screens for displaying data subject to the control of said operation buttons, and a second game table, which has a sabot holding a set of playing cards, a mechanical arm provided with a suction cup and operable to deal the playing cards, an image sensor for picking up the image of the card face of every dealing playing card, a display screen for showing the image of the card face picked up by the image sensor, and a card rack for showing the cards picked up by the mechanical arm and said suction cup.

### BACKGROUND OF THE INVENTION

1. Field of the Invention

The present invention relates to poker games and more particularly, to a poker game table, which allows many people to play the game at a time and which automatically deals the cards during the game.

2. Description of the Related Art

A poker game table is known using an electronic technology to deal virtual playing cards subject to the control of a computer program. Using a computer program to control dealing of virtual playing cards cannot eliminate a trick. Therefore, the justice of the game through this design of poker game table is doubted. There is known other poker game tables, which require a person to deal the cards during the game. Dealing the cards by a person requires much labor cost and cannot eliminate human tricks.

### SUMMARY OF THE INVENTION

The present invention has been accomplished under the circumstances in view. It is the main object of the present invention to provide a poker game table, which automatically deals the cards during the game, preventing human trick and assuring justice. To achieve this and other objects of the present invention, the poker game table is comprised of a first game table and a second game table. The first game table has a first table top provided with sets of operation buttons mounted and a second table top marked with the game rules and equipped with LCD screens for displaying data subject to the control of said operation buttons. The second game table has a sabot holding a set of playing cards, a mechanical arm provided with a suction cup and operable to deal the playing cards, an image sensor for picking up the image of the card face of every dealing playing card, a display screen for showing the image of the card face picked up by the image sensor, and a card rack for showing the cards picked up by the mechanical arm and said suction cup.

### BRIEF DESCRIPTION OF THE DRAWINGS

FIG. 1 is an exploded view of a poker game table in accordance with the present invention.

FIG. 2 is a perspective view of the present invention, showing the poker game table in operation.

### DETAILED DESCRIPTION OF THE PREFERRED EMBODIMENT

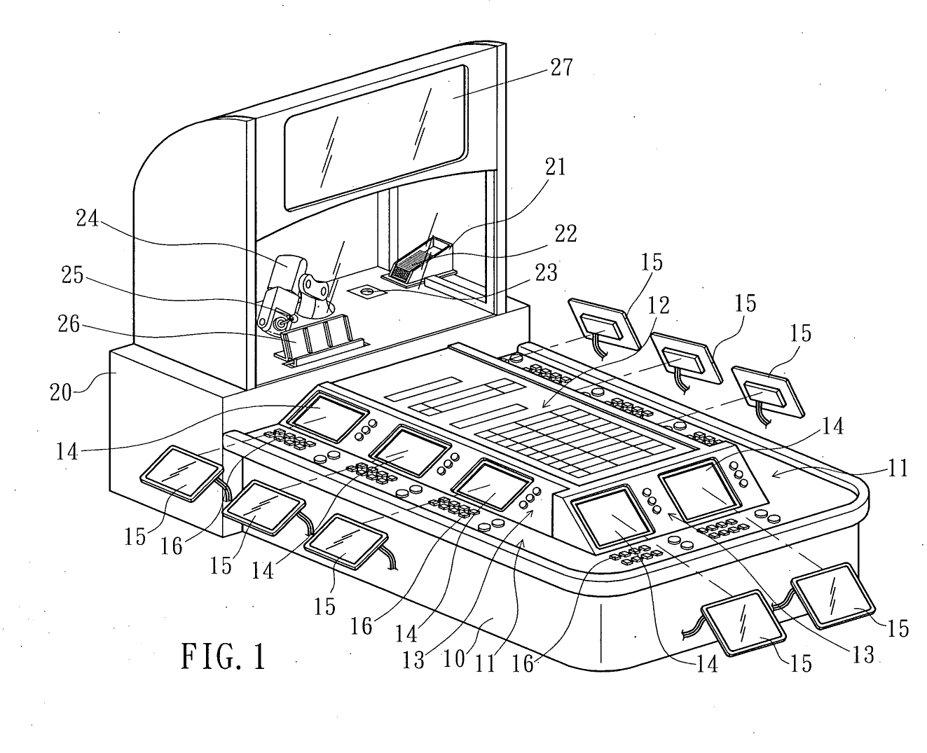

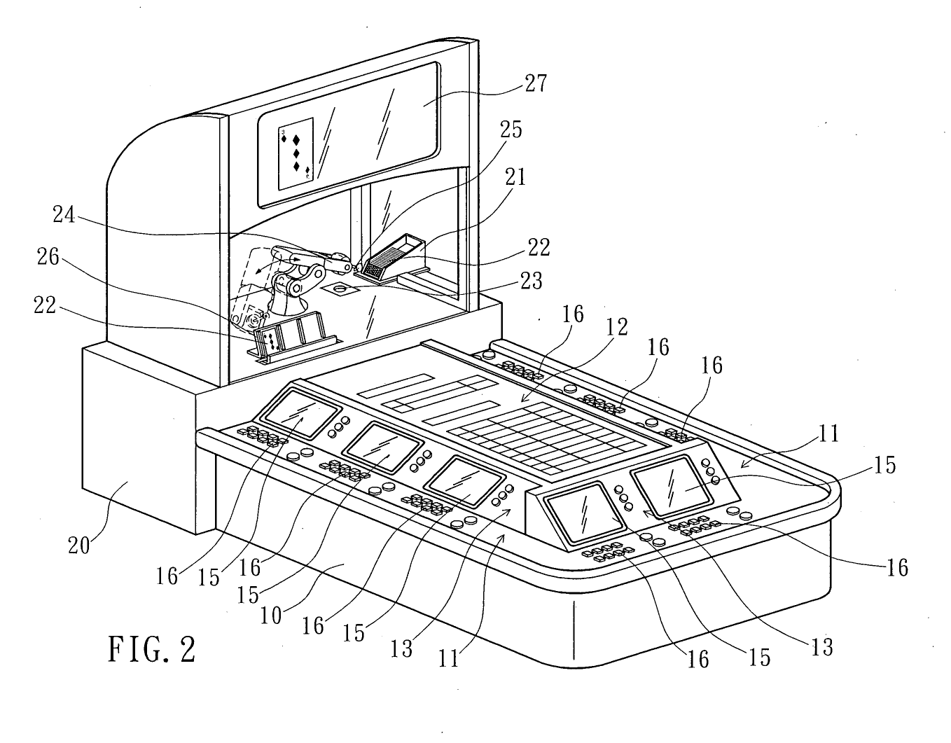

Referring to FIGS. 1 and 2, a poker game table in accordance with the present invention is shown comprised of a first game table 10 and a second game table 20. The first game table 10 comprises a first table top 11, multiple sets of operation buttons 16 mounted in the first table top 11, and a second table top 12 raised from the top side of the first table top 11 at the center. The second table top 12 has its flat top wall marked with the game rules, a plurality of sloping peripheral walls 13, a plurality of openings 14 cut through the sloping peripheral walls 13, and a plurality of LCD screens 15 respectively mounted in the openings 14. The second game table 20 comprises a sabot 21 holding a set of playing cards 22, a mechanical arm 24 provided with a suction cup 25 for dealing the playing cards 22, an image sensor 23 for picking up the image of the card. face of every playing card 22 that is picked up by the suction cup 25, and a display screen 27 for showing the image of the card face picked up by the image sensor 23, and a card rack 26 for showing the cards picked up by the suction cup 25.

Referring to FIG. 2 again, the invention allows many persons to play the game at a time. The players are sitting around the first table top 11 of the first game table 10. The players can operate the operation buttons 16 to play the game subject to the game rules marked on the flat top wall of the second table top 12, and watch the game rules displayed on the respective LCD screens 15. The second game table 20 works as the dealer, i.e., the mechanical arm 24 and the suction cup 25 are operated to deal the playing cards 22. When picked up one playing card 22, the mechanical arm 24 drives the suction cup 25 to carry the playing card 22 to the image sensor 23, enabling the image sensor 23 to pick up the image of the card face of the playing card 22 and to transmit the image of the card face of the playing card 22 to the display screen 27 for display. Thereafter, the mechanical arm 24 drives the suction cup 25 to carry the playing card 22 to the card rack 26 and put the playing card 22 in the card rack 26.

As stated above, the invention allows many persons to play the game at a time. The invention needs not to deal the playing cards by a person, i.e., the invention allows card dealing, card recognition, card moving, and card displaying actions to be done by poker game table automatically. Therefore, the invention saves much labor. Because the invention eliminates human trick, the invention assures justice.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A poker game table comprising
a first game table, said first game table comprising a first table top, multiple sets of operation buttons mounted in said first table top, and a second table top raised from said first table top, said second table top having a flat top wall thereof marked with the game rules, a plurality of sloping peripheral walls, a plurality of openings cut through said sloping peripheral walls, and a plurality of LCD screens respectively mounted in said openings; and
a second game table, said second game table comprising a sabot holding a set of playing cards, a mechanical arm provided with a suction cup and operable to deal said playing cards, an image sensor for picking up the image of the card face of every playing card that is picked up by said mechanical arm and said suction cup, a display screen for showing the image of the card face picked up by said image sensor, and a card rack for showing the cards picked up by said mechanical arm and said suction cup.
